(19) United States
(12) Patent Application Publication
(10) Pub. No.: US 2004/0083213 A1
(43) Pub. Date: Apr. 29, 2004

(54) Solution search

(76) Inventors: Yuh-Cherng Wu, San Jose, CA (US); Huiling Gong, Sunnyvale, CA (US); Mathias Kaiser, Mountain View, CA (US); Yijeng Liu, San Jose, CA (US); Christopher Ronnewinkel, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/365,671

(22) Filed: Feb. 12, 2003

Related U.S. Application Data
(60) Provisional application No. 60/421,650, filed on Oct. 25, 2002.

(51) Int. Cl. G06F 7/00

(52) U.S. Cl. 707/4

(57) ABSTRACT

Various implementations for solution searching are provided. One implementation provides for solution searching during a session with a user. The user creates a search request for one or more solutions. A data store provides one or more refinement criteria that are displayed to the user. The refinement criteria are associated with the search request. The user then selects one or more of the refinement criteria. In response, the data store provides one or more solutions that are displayed to the user, the solutions being associated with the search request and the selected refinement criteria. The user selects one or more of the solutions. The search request, the selected refinement criteria, and the selected solutions for the session are then stored in the data store.

### RELATED APPLICATION

The present application claims the benefit of the filing date of U.S. Provisional Application No. 60/421,650, which was filed on Oct. 25, 2002. The contents of U.S. Provisional Application No. 60/421,650 are hereby incorporated by reference into the present application in their entirety.

### TECHNICAL FIELD

This invention relates to computing systems, and more particularly to search operations conducted within such systems.

### BACKGROUND

In today's business society, customer relations and customer satisfaction are critical for successful and profitable operations. Customers are purchasing various products and services from a variety of providers, and use various purchase means. Some customers may make their purchases in person, while others may do so over the telephone. Additionally, the increased use of the Internet as a transaction venue has increased the number of customers who make purchases online.

When customers purchase various products and services, they often have questions, concerns, or complaints about their purchases. For example, a customer who has purchased a camera may have questions about how to use certain camera features, or may submit a complaint regarding a malfunction with the camera. A customer who has purchased service connectivity from an Internet Service Provider (ISP) may have questions about pricing options, or may have complaints concerning modem connectivity problems. To maximize customer satisfaction, businesses must be capable of responding quickly and effectively to customer questions, concerns, or complaints.

Many businesses employ customer care agents who are responsible for interacting with customers. These agents may interact with customers personally or over the telephone. More recently, many customer care agents engage in interactive chat sessions with customers over the Internet. These chat sessions allow agents to communicate quickly and easily with customers all over the world.

When such agents interact with customers, they often need to be able to address a wide variety of questions, and provide detailed and effective answers. To do so, the agents often require additional information and/or assistance. As customer care centers have evolved, more and more customer care agents have been able to utilize on-line repositories for obtaining information. These repositories often contain valuable information relating to offered products and services. This information provides the agents with a means to assist their customers and provide valuable feedback.

Many of these repositories, however, contain an abundance of information. Often, customer care agents have a very difficult time sifting through these repositories to find the most pertinent and valuable information. In addition, in those situations in which businesses allow customers to directly search the repositories for answering their questions and concerns, the same issues arise—customers often cannot find what they want or the solutions they need.

### SUMMARY

Various implementations for solution searching are provided. One implementation provides for solution searching during a session with a user. The user creates a search request for one or more solutions. A data store provides one or more refinement criteria that are displayed to the user. The refinement criteria are associated with the search request. The user then selects one or more of the refinement criteria. In response, the data store provides one or more solutions that are displayed to the user, the solutions being associated with the search request and the selected refinement criteria. The user selects one or more of the solutions. The search request, the selected refinement criteria, and the selected solutions for the session are then stored in the data store.

Advantages of certain implementations of the invention may be one or more of the following. A user having a particular problem is able to conduct and save a solution search session. The user is able to enter various search terms or attribute criteria relating to the problem, and is then presented with associated features for these terms or attributes. The user is able to select one or more of these features as search refinement criteria, and submit a request for a more refined solution search. After obtaining a set of potential solutions in response to the request, the user is able to select one or more of these solutions and add them to a solution cart, where they can be further forwarded to a customer using various forms of communication (such as email). Upon completion of the search, the user may save the entire solution search session for later use.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram of a method for implementing a solution search session.

FIG. 2 illustrates a block diagram of a system for implementing a method similar to the one shown in FIG. 1.

FIG. 3 illustrates a use case diagram involving various components shown in FIG. 2.

FIG. 4 illustrates a screen display of a solution search session, according to one implementation.

FIG. 5 illustrates a screen display of attribute selection during a solution search session, according to one implementation.

FIG. 6 illustrates a screen display containing detailed solution information for a solution search session, according to one implementation.

FIG. 7 illustrates a screen display of an interaction record, according to one implementation.

FIG. 8 illustrates another screen display for a solution search session, according to one implementation.

FIG. 9 illustrates a screen display for communication of a solution to a customer, according to one implementation.

### DETAILED DESCRIPTION

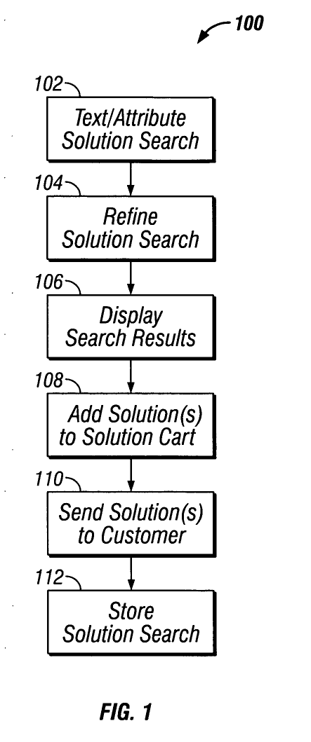

FIG. 1 is a flow diagram of a method for implementing a solution search session. In this implementation of the invention, a user is capable of initiating a search, refining the search, selecting a solution, sending the solution to a customer, and saving the entire solution search. In this fashion, a user is able to obtain a set of detailed solutions to a problem. In one implementation, the user is a call center agent working to address customer issues. A customer may call the agent with a problem. The agent is able to conduct a search, using search terms that pertain to the problem. After refining the search, the agent is presented with a list of potential solutions. The agent can select one or more of these solutions, and send them (via phone, email, fax, etc.) to the customer. The agent can also save the entire solution search (including the problem search, refinement details, and selected solutions) for later use by the same or other agents who may interact with a given customer.

In FIG. 1, flow diagram 100 illustrates one implementation of solution searching. At 102, a user (such as a call center agent) begins a text or attribute solution search. The user can enter one or more textual search terms (separated by Boolean operators, in one implementation), or may alternatively enter one or more search attributes. The textual search terms or search attributes relate to a particular problem. The user will implement a solution search to query for potential solutions to this problem, using a data store (according to one implementation).

At 104, the user refines the solution search. In one implementation, the user is presented with one or more refinement criteria using a graphical user interface (GUI). The refinement criteria may include terms, attributes, features, etc., that relate to the search initiated at 102. The user may select one or more of these refinement criteria to further refine the scope of the solution search.

At 106, the search results are displayed to the user. In one implementation, the search results are obtained from a search engine that maintains an index of entries into a data store. The data store contains various forms of knowledge information compiled and updated over time (in one implementation). The data store includes various solutions for business scenarios (in one implementation), and is organized according to a classification scheme. The user may view the displayed search results at 106, and may also obtain more detailed information about a given solution as well.

At 108, the user adds one or more displayed solutions to a solution cart using a GUI. The solution cart is a repository for selected solutions in a given session with a customer (in one implementation). Various solutions can be added or removed from the solution cart over the course of a session. By adding a solution to the solution cart at 108, the user is preparing to communicate this solution to the customer.

At 110, the user sends the solutions selected in the solution cart to the customer. The user can do so using email, fax, phone, etc., communication. For example, after adding a solution to the solution cart using the GUI, a call center agent may then email the solution to the customer, so that the customer can read (and implement) the details of the solution.

Finally, at 112, the entire solution search is stored for later use. The search, the refinement details, and the solutions selected and sent to the customer, may all be saved for later use by the same or other call center agents for later purposes. The information for the solution search is saved as a record for the given customer, and can be retrieved later. The information may also be used, in one implementation, for statistical analysis across a set of different customers to assess customer satisfaction with solutions. In one implementation, customer feedback for given solutions is also saved.

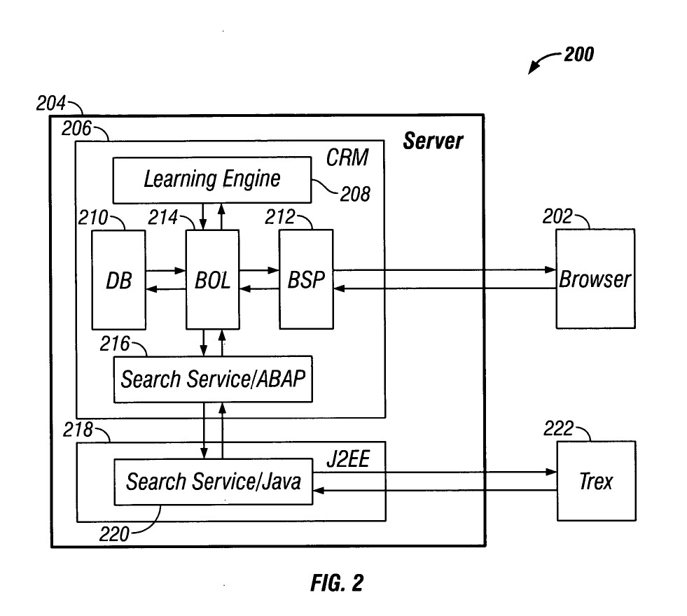

FIG. 2 illustrates a block diagram of a system for implementing a method similar to the one shown in FIG. 1. In this implementation, system 200 includes browser 202, server system 204, and retrieval and classification (TREX) engine 222. A user, such as a call center agent, may use browser 202 to interact with server system 204 (which interacts with TREX engine 222) to implement solution searching. Search requests are sent from browser 202 to server system 204. Server system 204 then sends these requests to TREX engine 222 (along with refinement criteria selected by a user, in one implementation), which provides a set of potential solutions. The list of potential solutions is sent back to browser 202, at which point a user of browser 202 may select one or more of the solutions and forward to a customer. The solution session is then saved on server system 204.

Browser 202 is a web-enabled browser, in one implementation. Browser 202 may be, for example, an Internet Explorer, Netscape, Mozilla, Opera, or similar browser. A user, such as a call center agent, may use browser 202 to initiate a solution search, select solutions, send the solutions to a customer, and save the solution session. In another implementation, a customer directly may use browser 202 to initiate a solution search, obtain results, and save the solution session.

Server system 204 includes server 206 and server 218 (which are operatively coupled). In one implementation, server 206 is an ABAP server (providing a customer relationship management, or CRM, solution). ABAP is an object-oriented programming language implemented in many SAP e-business solutions. As shown in FIG. 2, server 206 includes learning engine 208, database (DB) 210, business server pages (BSP) 212, business object layer (BOL) 214, and search service 216. In the implementation shown in FIG. 2, search service 216 is operable by using the ABAP language. These various components of server 206 interrelate to provide a search interface with browser 202. Learning engine 208 interacts with BOL 214. BOL 214 contains the business layer functionality for server 206. In one implementation, BOL 214 contains business objects (within a business model) for achieving one or more business purposes. BOL 214 interacts with DB 210. DB 210 stores the knowledge for the particular e-business solutions implemented by server system 206. Learning engine 208 processes information acquired through the course of transactions (including those generated by browser 202), and uses the information to make intelligent decisions in current and subsequent transactions. Such information is stored in DB 210 via processing through BOL 214. BSP 212 is the direct interface with browser 202. Requests from browser 202 are processed by BSP 212, and responses are sent back to browser 202. Search server 216 manages search requests within server 206, and also serves as an interface with server 218.

During operation, search requests are sent by browser 202 to BSP 212 (using business server page technology, in one implementation). BSP 212 forwards the request to BOL 214, which processes the request using various business objects through the business layer. BOL 214 then sends the request to search service 216, which then forwards the request to server 218. Upon receiving search results from server 218, learning engine 208 and DB 210 are queried for similar features, terms, attributes, etc., that relate to the search results, and these are categorized as refinement options (or criteria). The search results and refinement options are sent to browser 202 using BSP 212. If a user selects one or more of the refinement options, the selections are sent from browser 202 to BSP 212, and a refined search is conducted (sending the search request and refinement options to server 218). Revised search results are obtained from server 218 and sent to browser 202 for selection. Once a solution (via the search results) are selected by a user on browser 202, DB 210 stores the entire solution search session.

Server 218 is a Java (J2EE) server, in one implementation. Server 218 is used to implement various run-time session functionalities, including solution searching. In one implementation, server 218 provides a multi-threaded execution environment. Server 218 provides a different functionality than server 206 (in one implementation), and thereby achieve distributed server functionality within server system 204. Server 218 includes search service 220. In the implementation shown in FIG. 2, search service 220 is operable using the Java language. Search service 220 communicates with search service 216 within server 206. Search requests are sent from search service 216 to search service 220 for processing. These search requests could include both original search requests initiated by browser 202, as well as refined search requests (which include the original search request and one or more refinement criteria). These search requests are sent from search service 220 to TREX engine 222, and results (solutions) obtained from TREX engine 222 are sent from search service 220 back to search service 216.

TREX engine 222 is a search and classification engine. TREX engine 222 is a search engine responsible for carrying out search and classification activities. TREX engine 222 uses an indexing scheme for achieving fast and effective searching functions. When TREX engine 222 receives a search request from search service 220, it uses its index to obtain search results (i.e., solutions). It then sends the results back to search service 220. As TREX engine 222 is used over time, the index is continually updated for more efficient and accurate use. In one implementation, TREX engine 222 indexes its entries based on the contents of DB 210. The contents of DB 210 are organized using a predefined approach and appropriately indexed in TREX engine 222.

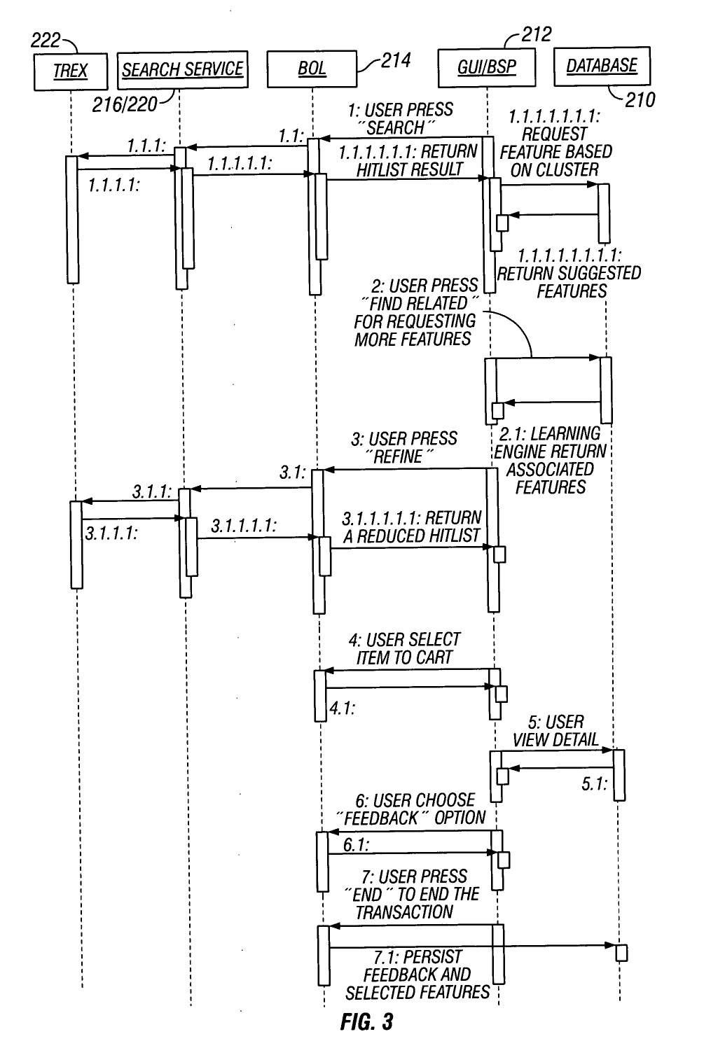

In other implementations, TREX engine 222 is replaced by other similar search engines. The operation of system 200 will be further illustrated in FIG. 3 below.

FIG. 3 illustrates a use case diagram involving various components shown in FIG. 2. In FIG. 3, the use case involves the following actors: database 210, GUI/BSP 212, BOL 214, search services 216 and 220, and TREX 222. The use case shows the details of implementing various aspects of a solution search, including search requests, refinements, solution display, solution cart operations, feedback, and solution search storage (i.e., persistence). Various operations are shown as numbered flows between actors. For example, a first flow begins with operation 1, a second flow begins with operation 2, and so on.

In the use case shown in FIG. 3, the first flow begins with operation 1 when a user (on browser 202, for example) presses a “search” button. By pressing the “search” button, an initial solution search request is sent from GUI/BSP 212 to BOL 214 for processing. BOL 214 sends the request to search service 216 (which routes the request to search service 220) in operation 1.1 (as indicated by the arrow in FIG. 3). In operation 1.1.1, search service 220 sends the search request to TREX engine 222. As described in reference to FIG. 2, TREX engine 220 uses an index to search and retrieve results (i.e., solutions) in response to the request it receives from search service 220. In one implementation, the index corresponds to entries found within database 210. TREX engine 222 does not directly access database 210 during the retrieval operation, but simply accesses its index (which has been formatted according to an earlier interaction with database 210. In operation 1.1.1.1, TREX engine 222 sends search results (in the form of a hitlist) back to search service 220, which forwards the results to search service 216. In operation 1.1.1.1.1, search service 216 sends the results to BOL 214. BOL 214 processes these results using the appropriate business objects (within the business layer), and then sends the results to GUI/BSP 212 in operation 1.1.1.1.1.1. All of the results are grouped within a cluster. In one implementation, the results include documents that include solutions for responding to user questions. In operation 1.1.1.1.1.1.1, GUI/BSP 212 submits a request from database 210 for features that are based on the result cluster. During this operation, database 210 determines attributes, features, criteria, etc. that are related, or common to, all of the results in the cluster. For example, if the results included “tires” and “steering wheel,” then related features could include “car parts” and “round objects.” In one implementation, the results in the hitlist each contain a set of keywords associated therewith. They keywords associated with a given result may pertain, in one implementation, to the contents of the result (e.g., in a document). Database 210 cross-references all of they keywords for each of the results in the cluster, and determines a set of common keywords. These common keywords are used to create the features. Database 210 sends these related features back to GUI/BSP 212 in operation 1.1.1.1.1.1.1.1. GUI/BSP 212 may then send these related features to browser 202, so that a user may select one or more of the features as refinement criteria (for the solution search). A search may be narrowed by using such refinement criteria in a subsequent search.

An optional second flow begins with operation 2. Operation 2 will only occur if the user presses a “find related” button for requesting more features. After GUI/BSP 212 has sent the related features (as refinement criteria) to browser 202, the user may make submit a request to find related features. In this case, GUI/BSP 212 will submit a request for related features to database 210. Database 210 will communicate with learning engine 208 (shown in FIG. 2) to locate and/or identify any other related features that could be pertinent to the solution search. In operation 2.1, database 210 will send any related (or associated) features back to GUI/BSP 212. GUI/BSP 212 is then able to forward these features to browser 202 for display to the user.

A third flow begins with operation 3. Operation 3 is triggered by the user pressing the “refine” button on browser 202. After viewing a set of search results and refinement criteria on browser 202, a user can select one or more of the refinement criteria and submit a new search by using the “refine” button (in one implementation). When this occurs, GUI/BSP 212 sends a further search request to BOL 214. This subsequent search request will include, in one implementation, the original search request and the selected refinement criteria (which will be used to narrow the search). In operation 3.1, BOL 214 sends the request to search services 216, and search service 220 sends the request to TREX engine 222 in operation 3.1.1. TREX engine uses its index to obtain a refined set of search results (in the form of a reduced hitlist), and returns the results to search service 220 in operation 3.1.1.1. In operation 3.1.1.1.1, search service 216 sends the results to BOL 214, and in operation 3.1.1.1.1.1, BOL 214 sends the results to GUI/BSP 212. At this point, GUI/BSP 212 is capable of sending the set of refined search results back to the user on browser 202. The user is then displayed the narrowed set of results for selection.

A fourth flow begins in operation 4 when the user selects one or more of the search results (e.g., solutions for a problem that was searched) and adds them to a solution cart. When this occurs, GUI/BSP 212 interacts with BOL 214 in operations 4 and 4.1. BOL 214 will update the business model accordingly, to indicate which of the solutions have been selected by the user.

An optional fifth flow begins in operation 5 when the user chooses to view details of a particular solution result. In one implementation, the user views the details before adding the solution to the solution cart, and in another implementation views the details after adding to the cart. The solution details provide the user with specific information relating to the solution. In operations 5 and 5.1, GUI/BSP 212 interacts with database 210 to obtain the details for a particular solution, and send such details back to browser 202.

In addition, a user (who is using browser 202) may send solutions from the solution cart to a customer. For example, the user (such as a call center agent) may email or fax these solutions to a customer.

A sixth flow begins in operation 6 when the user chooses a “feedback” option. In this flow, a user has already selected a given solution in browser 202, and provides feedback about the solution. In one implementation, the user provides feedback regarding the relevance or effectiveness of the solution. For example, after obtaining a solution from a call center agent, a customer may respond by saying that the solution fixed his/her problem. In this case, the call center agent could add this feedback into the system by pressing a “feedback” button. GUI/BSP 212 interacts with BOL 214 (in operations 6 and 6.1) to process this feedback into the business model.

A seventh flow begins in operation 7 when the user ends a transaction with a customer (by pressing the “end” button, for example). When the solution search session has ended, GUI/BSP 212 sends a message to BOL 214 in operation 7. BOL 214 processes this information in the business model, and saves (i.e., persists) the solution search session in database 210. In one implementation, the solutions selected in the solution cart (by the user) are saved. In one implementation, the feedback and selected features (for the refinement criteria) are also saved.

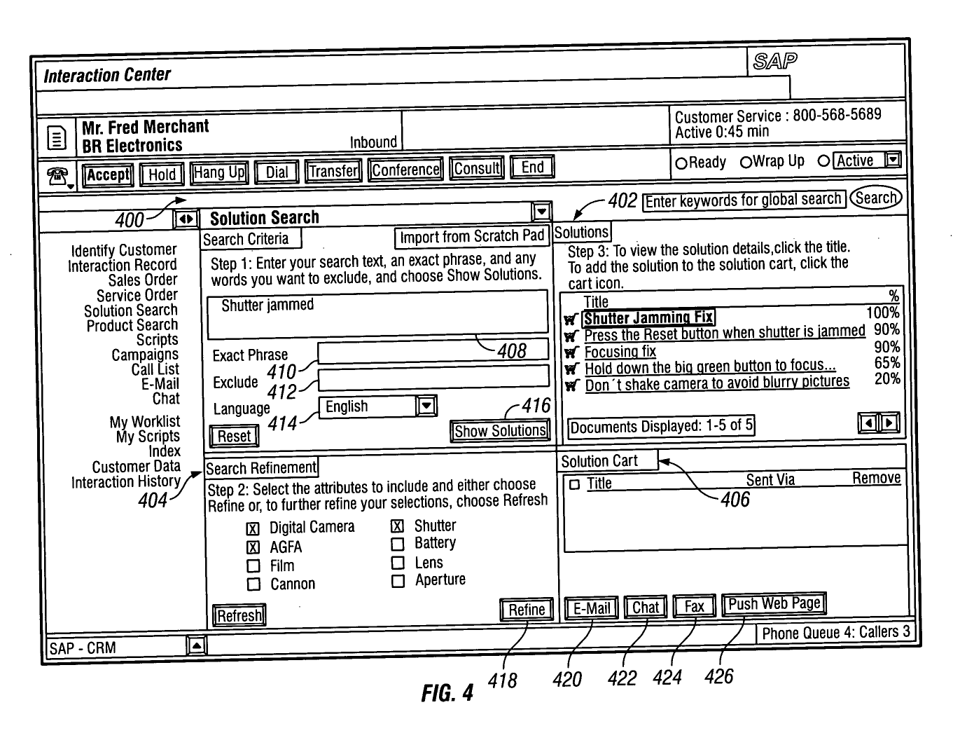

FIG. 4 illustrates a screen display of a solution search session, according to one implementation. In this implementation, the screen display may be included on a browser, such as browser 202 shown in FIG. 2. The screen display includes search area 400, refinement area 404, solution display area 402, and solution cart area 406. Using the GUI for the screen display shown in FIG. 4, a user (such as a call center agent) is capable of retrieving solutions based on search criteria, adding selected solutions to a solution cart, sending solutions to a customer, and saving the entire solution search (including refinement criteria) for later use.

In one implementation, the screen display of FIG. 4 shows a session in an Interaction Center. In this implementation, a call center agent is conversing with a customer via telephone, and is assisting the customer with a problem request. As shown, the customer's name is “Mr. Fred Merchant” who works with “BR Electronics.” The customer is calling the agent to obtain assistance in addressing a particular problem. After the agent has discussed the problem with the customer, the agent can initiate a solution search by entering information into search area 400.

Search area 400 provides a user with the means for entering various search criteria. The first step in the solution search process is to enter text in text field 408. A call center agent, in one implementation, may primarily use a natural language search method to search for solutions using text field 408. Various phrases, such as “Shutter jammed,” may be inserted into text field 408. Multiple phrases may be separated by a comma. In one implementation, text field 408 is pre-populated with information (such as product information) as a result of prior transactions with the given customer. This provides the call center agent with immediate information that may be pertinent to the current problem encountered by the same customer.

While a natural language search can be conducted using text field 408, a user may conduct an exact phrase search using exact phrase field 410. The user may enter one or more exact phrases into exact phrase field 410 separated by Boolean operators (e.g., AND, OR, etc.). A user may also wish to exclude certain terms or phrases from a solution search. That is, the user may wish to filter out results containing certain terms or phrases. The user may enter such terms or phrases into exclusion field 412 (and may use, in one implementation, Boolean operators as separators). The default language for the solution search is English, but the user may select another language using language pull-down menu 414. After the user had entered all search criteria, he/she may push the “Show Solutions” button (using the GUI) to initiate the search.

The next step in the solution search process is to refine (or narrow) the initial search. After the initial search is conducted, an initial set of search results will be shown in solution display area 402, and various refinement features (or criteria) will be shown in refinement area 404. As shown in FIG. 4, the refinement features are itemized with checkboxes. The user is capable of selecting one or more of those features to refine the solution search. These features relate to the initial search text of “Shutter jammed” that had been entered in text field 408. After selecting one or more of the features, the user may select the “Refresh” button to further refine the selection within refinement area 404, or may select the “Refine” button 418 to conduct a refined (i.e., narrowed) search using the original text from search area 400 and the refinement criteria selected in refinement area 404. After the refined search is complete, the initial set of search results earlier shown in solution display area 402 will be updated and/or replaced with a refined set of search results. In a different implementation, the search results are only shown in solution display area 402 after the refined search is complete.

The third step in the solution search process is to view and select displayed solutions. Solution display area 402 shows various solutions that have been retrieved according to the refined search. As shown in solution display area 402, one solution is displayed per row. The title of the solution is included, as well as the estimated relevance. The solutions with the highest-rated relevance are shown at the top of the list. The user may view the details of a particular solution by selecting (or clicking on) the title. In this case, the solution details are displayed in a separate window (in one implementation). The user may also add a solution to the solution cart by selecting the cart icon located to the left of the solution title.

Solutions that have been added by the user to the solution cart will be displayed in solution cart area 406. After the user had added a given solution to the solution cart, the user can then send the solution to a customer using various forms of communication. The user may email the solution to the customer by selecting “E-Mail” button 420. Alternatively, if the user has engaged in an interactive chat session with the customer, the user can send the solution to the customer via the chat session by selecting “Chat” button 422. If the customer would prefer fax communications, the user may send a fax solution by selecting “Fax” button 424. Or, the user may simply send the solution as a web page to the customer by selecting “Push Web Page” button 426. Solution cart area shows three columns for each solution that is added: “Title,” “Sent Via,” and “Remove.” The “Title” column provides a descriptive title of a solution. The “Sent Via” column indicates if and how a solution has been sent to a customer. If the entry is blank, then no solution has been yet sent to the customer. Otherwise, the entry will indicate the means by which the solution was sent (e.g., e-mail, chat, fax, etc.). The “Remove” column indicates whether the solution is to be removed from the solution cart.

After the transaction between the user and customer has completed, the entire solution search session may be saved in a database, such as database 210 shown in FIG. 2. The session may later be retrieved by the same call center agent, or by other agents, when similar searches are required, or when past solution search histories are requested for a given customer.

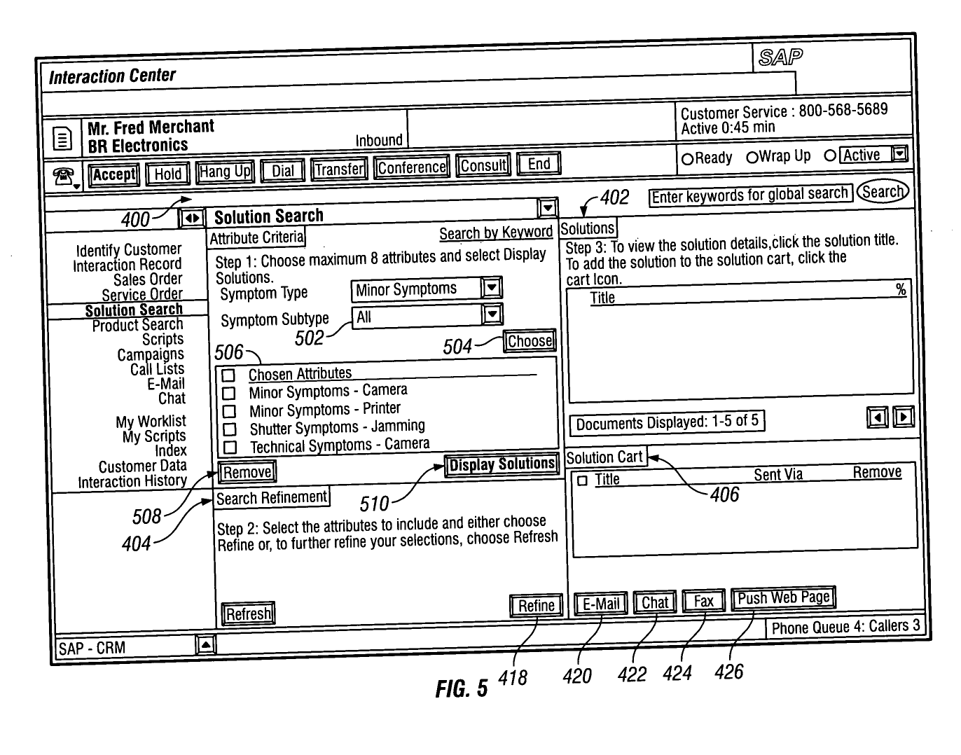

FIG. 5 illustrates a screen display of attribute selection during a solution search session, according to one implementation. In this implementation, a user (such as a call center agent) may initiate a solution search by selecting one or more attribute criteria that relate to a given problem. For example, in a session with a customer, a call center agent may help identify the customer's problem, and enter certain attribute criteria to search for various solutions.

The screen display shown in FIG. 5 includes search area 400, refinement area 404, solution display area 402, and solution cart area 406. Certain aspects of these screen areas were described with reference to FIG. 4. Search area 400 shown in FIG. 5, however, displays attribute search information. A user may first use drop-down menu 500 to select a symptom type. The symptom type relates to a symptom of the problem that a given customer may be having, and is a high-level (broad) category. As shown in FIG. 5, the user has selected a symptom type of “Minor Symptoms.” The user may then use drop-down menu 502 to select a symptom subtype. The symptom subtype is a sub-category of the symptom type. In one implementation, the selections offered in drop-down menu 502 are based on the selection for symptom type in drop-down menu 500. After the user has selected a symptom type and a symptom subtype, he/she may click on “Choose” button 504 to obtain a display of attributes.

After the use has made this selection, a request is sent for attributes conforming to the selected symptom type and subtype. In one implementation, the screen display of FIG. 5 is shown in browser 202 (as shown in FIG. 2). An attribute request is sent from browser 202 to server system 204, and after server system 204 processes the request, an attribute list is returned to browser 202. Browser 202 will use this attribute list in displaying the attributes in attribute area 506 (as shown in FIG. 5). Each of the attributes includes in attribute area 506 conform to the selected symptom type and subtype. Each attribute includes a checkbox located to the left of the attribute text. The user may select one or more of these attributes by clicking on the appropriate check box. If the user wishes to de-select any choices, he/she may use “Remove” button 508. After the user is satisfied with the attribute selections, he/she may click on “Display Solutions” button 510 to perform a solution search based on these attributes.

After initiating the solution search, the subsequent steps for the search and selection process are similar to those described in reference to FIG. 4. The user may make search refinements in refinement area 404, and initiate a refined search by clicking on “Refine” button 418. The solutions returned from the refined search are displayed in solution display area 402, and selected solutions are displayed in solution cart area 406. A user may send selected solutions to a customer using buttons 420, 422, 424, and 426. Finally, after the session with the customer has ended, the entire solution search session is saved (such as in database 210, as shown in FIG. 2).

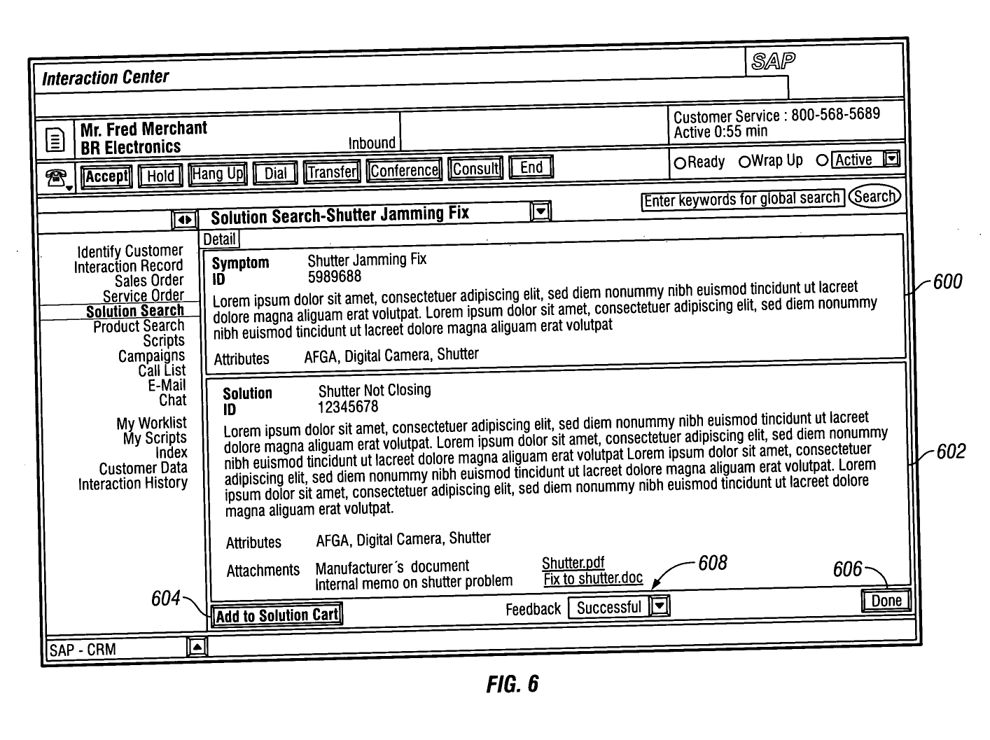

FIG. 6 illustrates a screen display containing detailed solution information for a solution search session, according to one implementation. In this implementation, the screen displays detailed information for a particular solution to a user (such as a call center agent). The user may wish to view this detailed information before adding the solution to the solution cart. In this case, the user selects the text of the solution in solution display area 402, and the detailed information (such as the information shown in FIG. 6) is then displayed in a separate window. Alternatively, in a different implementation, the user may view the detailed solution information after adding the solution to the cart (by selecting the solution in solution cart area 406). In this case, the user may wish to read the details before sending the solution to the customer.

The screen display in FIG. 6 includes symptom area 600 and solution area 602. Symptom area 600 displays the details relating to the symptom of a given problem. The symptom includes a title (“Shutter Jamming Fix”), and an ID. Symptom area 600 then displays the text relating to the symptom. As shown in FIG. 6, the symptom text may be displayed in an English or a non-English language. Finally, symptom area 600 displays the attributes selected or associated with the symptom.

Solution area 602 displays the details relating to the solution for a given problem. The solution includes a title (“Shutter Not Closing”), and an ID. Solution area 602 then displays the text relating to the solution. As shown in FIG. 6, the solution text may be displayed in an English or a non-English language. Solution area 602 displays the attributes selected or associated with the solution. Finally, solution area 602 displays one or more attachments. These attachments are related to the given solution, and may include such things as manufacturer's documents, internal memos, and the like. The attachments may be listed in various file formats, such as Portable Document Format (PDF), or the like. The user may simply select a given attachment to view its contents.

The screen display also shows optional feedback menu 608. A user, such as a call center agent, may use feedback menu 608 to select feedback evaluation for a given solution. In one implementation, feedback menu 608 is a pull-down menu providing a set of selectable feedback options. The feedback selection may be a result of customer input. For example, if a customer has been previously provided with a solution, the customer may later call back and provide feedback regarding the quality/effectiveness/etc. of the solution, and the call center agent may enter this feedback by selecting the appropriate option from feedback menu 608.

The screen display in FIG. 6 also shows “Add to Solution Cart” button 604, and “Done” button 606. In the implementation shown in FIG. 6, a user may wish to view symptom and solution details before adding a given solution to the solution cart. If, after reading the details, the user wishes to add the solution to the cart, he/she may select button 604. After the user is finished reading the symptom and solution details, he/she may select button 606.

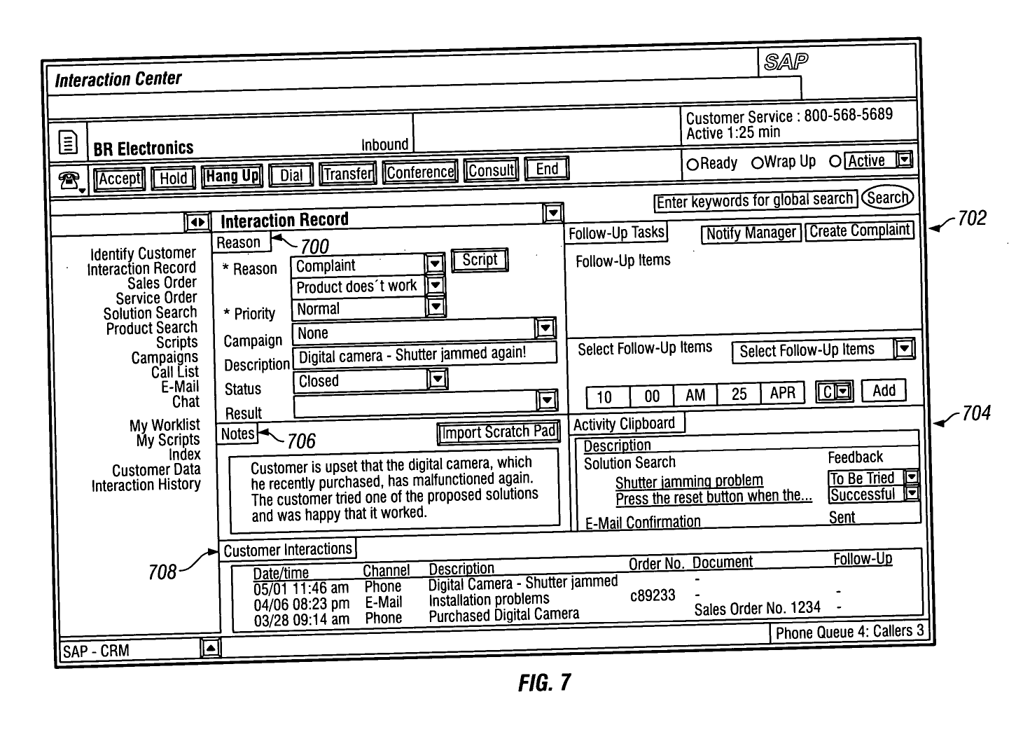

FIG. 7 illustrates a screen display of an interaction record, according to one implementation. In this implementation, the interaction record is used the capture the summary of solution search sessions with a customer. In this fashion, solution searches associated with a customer can be saved in the interaction record and later retrieved for use in later transactions or correspondence with the same customer. In one implementation, the interaction record of FIG. 7 is included in a run-time Interaction Center used by a call center agent. The customer is “BR Electronics.”

As shown in FIG. 7, the screen display for the interaction record includes reason area 700, notes area 706, task area 702, activity area 704, and interaction area 708. Reason area 700 includes information relating to the reason for the customer's call. A call center agent, in one implementation, may enter information into reason area 700. The call center agent may enter information relating to priority, description details, status, and the like. If the problem has been resolved, the agent may enter a status of “Closed.” Reason area 700 provides a high-level view of the reason why a customer has required a solution search to be conducted by the agent.

Notes area 706 includes various notes that may be entered by a user (such as a call center agent) that relate to the transaction with the customer. These notes may relate to the effectiveness of the solution search session, or other associated notes. The notes may be based on the agent's overall impression, or may be more specifically tied to actual feedback received from the customer. In the example shown in FIG. 7, notes area 706 includes a note indicating that the customer was happy with one of the proposed solutions.

Task area 702 displays various follow-up tasks with a customer that may be necessary. As a result of a solution search session, a call center agent may determine that follow-up action is required. The agent may enter follow-up tasks into task area 702, and also create timelines or due dates that are associated with such tasks.

Activity area 704 displays the description of the solution search session. The description of the problem and solution are displayed (for the solution search), and a user can click on the text to view more detailed information. In addition, the user may use the feedback pull-down menus to select appropriate feedback for a given solution. This feedback may be later used by other agents to assess the effectiveness or pertinence of certain solutions with regards to the customer. Alternatively, an agent may enter feedback by selecting the solution (e.g., by clicking on its title), and entering feedback on the detailed solution page (such as the one shown in FIG. 6 using feedback menu 608). Activity area 704 also shows if solutions have been sent to customers. In FIG. 7, activity area 704 indicates that an email confirmation has been sent.

Interaction area 708 contains a history of all interactions with a given customer, such as “BR Electronics.” Interaction area 708 is useful, because it provides summary information to a call center agent for prior interactions with a customer. An agent is able to see earlier problems that the customer has had, and the various solutions that have been used. These may be pertinent to subsequent interactions with the same customer. Interaction area 708 includes date/time information, communication information (i.e., means by which an agent communicated with the customer to provide solutions), problem/solution description information, order number information, document information (relating to the provided solutions), and follow-up (task) information.

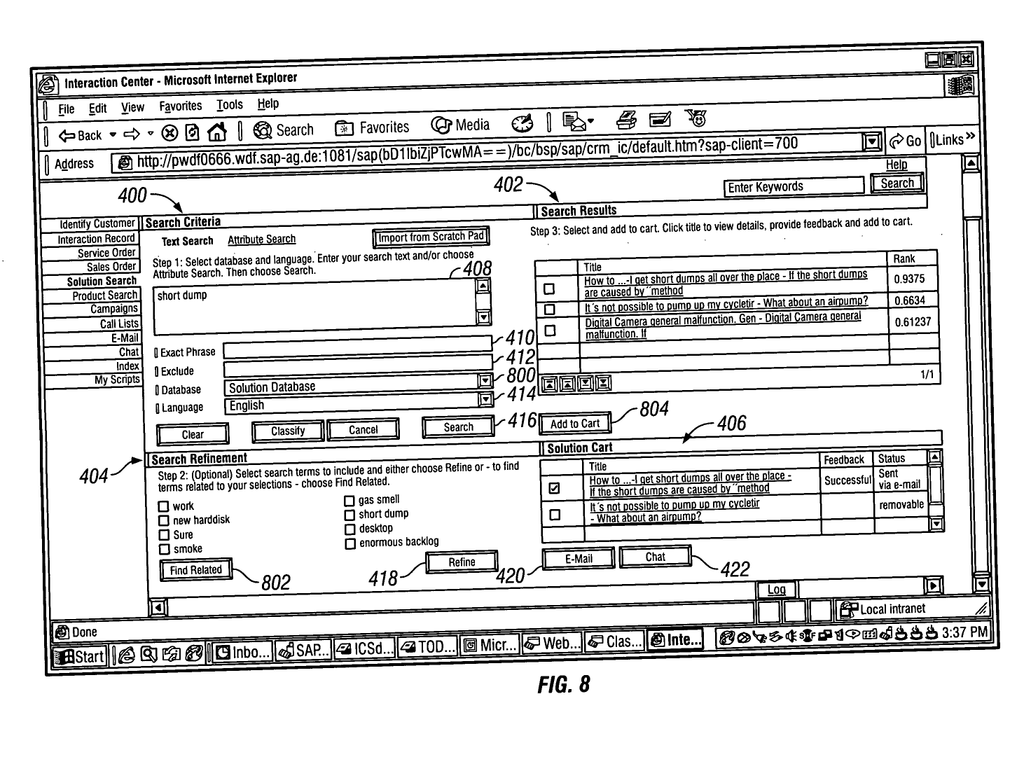

FIG. 8 illustrates another screen display for a solution search session, according to one implementation. In this implementation, a call center agent may use a browser (such as browser 202 shown in FIG. 2) to conduct a solution search session. The agent may enter search criteria, refine the search (as well as finding relating refinement criteria), view solutions, add solutions to a solution cart, and email solutions to a customer. After the session is complete, the user may also save the entire session for later use. In one implementation, the solution search session for the customer is saved in an interaction record (such as the one shown in FIG. 7).

The screen display shown in FIG. 8 includes search area 400, refinement area 404, solution display area 402, and solution cart area 406. Certain aspects of these screen areas were described with reference to FIG. 4. A user may enter search text (in natural-language format) into text field 408, and exact phrase terms into exact phrase field 410. The user may enter exclusion terms in exclusion field 412, and select a language using language pull-down menu 414. Additionally, the user may select a particular database for searching by using database pull-down menu 800. As shown in FIG. 8, the user has selected the “Solution Database.” Once the user has finished entering search terms, he/she may request an initial search by clicking on “Search” button 416.

The user may refine a solution search by using refinement area 404. The user may select one or more of the refinement criteria by selecting the appropriate checkboxes. The user may then request a refined search by clicking on “Refine” button 418. Before doing so, however, the user may first request a set of related criteria. To do so, the user will first select one or more of the listed criteria. The user will then click on the “Find Related” button 802. After doing so, refinement area 404 will display a set of related criteria from which to choose. The user may then select any of these related criteria, and then click on “Refine” button 418.

Various solutions will be displayed in solution display area 402 (i.e., the search results). In one implementation, the solutions will be displayed in a top-down descending rank order. That is, those solutions that are determined to be most relevant to the search criteria will be listed at the top, and will display a ranking percentage. The titles of the solutions are also shown. In one implementation, the user may select the title of a given solution to view the solution details. The user may add a solution to the solution cart by clicking the corresponding checkbox (to the left of the text), and then clicking on “Add to Cart” button 804.

Solutions that have been added to the solution cart are displayed in solution cart area 406. The titles of the solutions are shown, as well as any entered feedback relating to the solutions. If feedback has been previously entered and stored for a given solution, the feedback (status) will be displayed in the “Feedback” column. A call center agent may view the feedback as such. As shown in FIG. 8 (as an example), the first listed solution in the solution cart contains a feedback setting of “Successful.” This provides a user (such as a calling agent) with a quick and easy way to view feedback concerning a given solution from a customer.

Solution cart area 406 also includes a column labeled “Status.” A listed solution will have a status of“removable” until it is sent to a customer, in one implementation. An agent may add and remove solutions to the solution cart as desired. The agent may also, in one implementation, send any of the solutions in the solution cart to a customer. To do so, the agent simply needs to select the appropriate checkbox to the left of the solution, and click on either “E-Mail” button 420 or “Chat” button 422. By clicking on “E-Mail” button 420, the agent will send the solution to the customer via email. If the agent wishes, instead, to send the solution to the customer using an interactive chat session, the user may instead click on “Chat” button 422. Once the agent has sent a solution to the customer, the status (in the “Status” column) will indicate this (including the manner in which the solution was sent, such as by e-mail or by interactive chat). As shown in FIG. 8 (as an example), the first listed solution in the solution cart has a status of “Sent via E-Mail,” indicating that the solution has already been sent to the customer via e-mail.

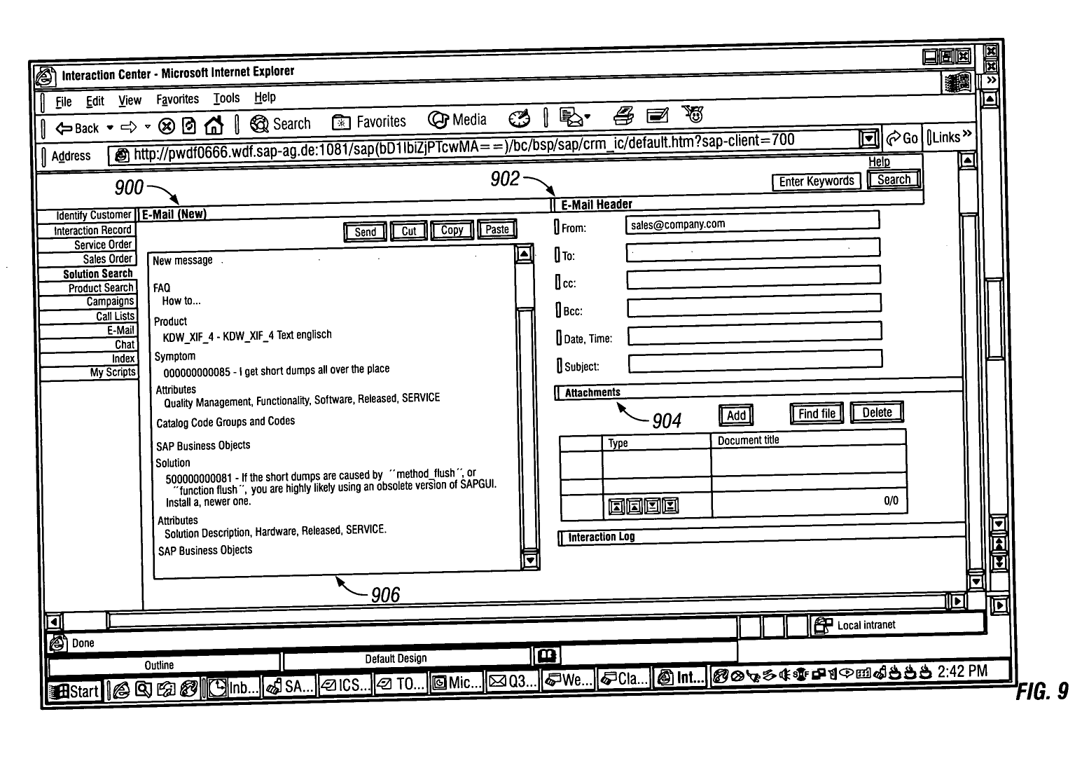

FIG. 9 illustrates a screen display for communication of a solution to a customer, according to one implementation. In this implementation, the screen display shows an email communication for a solution that can be sent by a call center agent to a customer. In one implementation, this screen display is shown after the agent clicks on “E-Mail” button 420 (as shown in FIG. 8, for example).

The screen display in FIG. 9 includes message area 900, header area 902, and attachment area 904. In message area 900, text field 906 includes the text of the email message that will be sent to a customer. In one implementation, the text within text field 906 is automatically populated with solution information after the call center agent clicks on “E-Mail” button 420. The text includes solution details, as well as attributes that relate to the solution. Header area 902 includes email header information, such as “From,” “To,” “Subject,” and the like. In one implementation, the “From” header field is automatically populated with the call center agent's email address. In one implementation, the “To” header field is also automatically populated with the customer's email address (though this is not shown in FIG. 9). Attachment area 904 includes various attachments that are to be included with the solution email. In one implementation, attachments pertinent to the solution are automatically included within attachment area 904. In one implementation, the call center agent is also able to manually attach files using the “Add” button. Once the agent has finished preparing the email, he/she may send it to the customer by clicking the “Send” button in message area 900. At this point, the solution will be emailed to the customer.

The various implementations of the invention described above provide many advantages. For example, a user having a particular problem is able to conduct and save a solution search session. The user is able to enter various search terms or attribute criteria relating to the problem, and is then presented with associated features for these terms or attributes. The user is able to select one or more of these features as search refinement criteria, and submit a request for a more refined solution search. After obtaining a set of potential solutions in response to the request, the user is able to select one or more of these solutions and add them to a solution cart, where they can be further forwarded to a customer using various forms of communication (such as email). Upon completion of the search, the user may save the entire solution search session for later use.

By saving a solution search session, later users (such as call center agents or customers) have access to prior session and search histories. For example, a call center agent may be able to view prior solution searches that were conducted for a given customer, and also view any feedback (e.g., from the customer) that is associated with any given solution that was provided to the customer. Additionally, the agent is able to enter additional feedback obtained from the customer after the customer has received one or more solutions (via transmission from the solution cart).

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method for providing a solution search during a session with a user, the method comprising:
receiving a user-initiated search request for one or more solutions;
sending one or more viewable refinement criteria from a data store to a display device, the refinement criteria being associated with the search request;
receiving a user-initiated selection of one or more of the refinement criteria;
sending one or more viewable solutions from the data store to the display device, the solutions being associated with the search request and the selected refinement criteria;
receiving a user-initiated selection of one or more of the solutions; and
storing the search request, the selected refinement criteria, and the selected solutions for the session in the data store.

2. The computer-implemented method of claim 1, wherein storing the search request, the selected refinement criteria, and the selected solutions for the session in the data store includes storing the search request, the selected refinement criteria, and the selected solutions for the session in the data store as an interaction record associated with a particular customer.

3. The computer-implemented method of claim 1, wherein the method further comprises:
processing an initial set of solutions from the data store, the initial set of solutions being associated with the search request and each having one or more keywords associated therewith; and
using the data store to obtain the viewable refinement criteria based on common keywords from the initial set of solutions.

4. The computer-implemented method of claim 1, wherein the method further comprises:
receiving user-initiated feedback associated with an evaluation of one or more of the solutions for the session; and
storing the feedback in the data store.

5. The computer-implemented method of claim 1, wherein the method further comprises:
receiving a user-initiated request for detailed information associated with one of the solutions; and
sending the detailed information, in viewable form, from the data store to the display device.

6. The computer-implemented method of claim 1, wherein the method comprises providing a solution search during a session with a user using a web-enabled interface.

7. The computer-implemented method of claim 6, wherein receiving a user-initiated search request for one or more solutions includes receiving a user-initiated text or attribute search request for one or more solutions.

8. In a computer system having a graphical user interface (GUI), a method for providing a solution search during a session with a user, the method comprising:
creating a search request for one or more solutions;
upon creation, displaying one or more refinement criteria relating to the search request;
selecting one or more of the refinement criteria;
upon selection, displaying one or more solutions relating to the search request and the selected refinement criteria;
selecting one or more of the solutions; and
initiating an event to store the search request, the selected refinement criteria, and the selected solutions for the session.

9. The method of claim 8, wherein initiating an event to store the search request, the selected refinement criteria, and the selected solutions for the session includes ending the session with the user.

10. The method of claim 8, wherein the method further comprises initiating an additional event to send the selected solutions to a particular customer.

11. The method of claim 10, wherein initiating an additional event to send the selected solutions to a particular customer includes sending the selected solutions to a particular customer using interactive chat functionality.

12. The method of claim 8, wherein the method further comprises entering user feedback to evaluate one of the selected solutions.

13. The method of claim 8, wherein the method comprises providing a solution search during a session with a user using a web-enabled interface.

14. The method of claim 13, wherein creating a search request for one or more solutions includes creating a text or attribute search request for one or more solutions.

15. The method of claim 13, wherein displaying one or more solutions relating to the search request and the selected refinement criteria includes displaying one or more solutions in an order that is ranked by relevance.

16. The method of claim 13, wherein displaying one or more solutions relating to the search request and the selected refinement criteria includes displaying detailed information of one or more of the solutions.

17. The method of claim 13, wherein selecting one or more of the solutions includes adding one or more of the solutions to a solution cart.

18. A computer-readable medium having computer-executable instructions contained therein for performing a method, the method comprising:
receiving a user-initiated search request for one or more solutions;
sending one or more viewable refinement criteria from a data store to a display device, the refinement criteria being associated with the search request;
receiving a user-initiated selection of one or more of the refinement criteria;
sending one or more viewable solutions from the data store to the display device, the solutions being associated with the search request and the selected refinement criteria;
receiving a user-initiated selection of one or more of the solutions; and
storing the search request, the selected refinement criteria, and the selected solutions for the session in the data store.

19. A computer-readable medium having computer-executable instructions contained therein for performing a method, the method comprising:
creating a search request for one or more solutions;
upon creation, displaying one or more refinement criteria relating to the search request;
selecting one or more of the refinement criteria;
upon selection, displaying one or more solutions relating to the search request and the selected refinement criteria;
selecting one or more of the solutions; and
initiating an event to store the search request, the selected refinement criteria, and the selected solutions for the session.

20. A system for providing a solution search during a session with a user, the system comprising:
a data store; and
an interface operable to:
receive a user-initiated search request for one or more solutions;
send one or more viewable refinement criteria from the data store to a display device, the refinement criteria being associated with the search request;
receive a user-initiated selection of one or more of the refinement criteria;
send one or more viewable solutions from the data store to the display device, the solutions being associated with the search request and the selected refinement criteria;
receive a user-initiated selection of one or more of the solutions; and
store the search request, the selected refinement criteria, and the selected solutions for the session in the data store.

21. The system of claim 20, wherein the interface is further operable to:
receive a user-initiated request for detailed information associated with one of the solutions; and
send the detailed information, in viewable form, from the data store to the display device.

22. The system of claim 20, wherein the interface is further operable to:
receive user-initiated feedback associated with an evaluation of one or more of the solutions for the session; and
store the feedback in the data store.

23. The system of claim 20, wherein the interface includes a web-enabled interface.

24. The system of claim 23, wherein the user-initiated search request includes a text or attribute search request.
